(19) United States
(12) Patent Application Publication
(10) Pub. No.: US 2026/0055761 A1
(43) Pub. Date: Feb. 26, 2026

(54) Stators for Eccentric Screw Pumps, Eccentric Screw Pump and Production Method

(71) Applicant: NETZSCH Pumpen & Systeme GmbH, Selb (DE)

(72) Inventors: Martin Zierhofer, Aschau am Inn (DE); Burim Djimsiti, Mettenheim (DE); Christian Hoffmann, Waldkraiburg (DE); Stefan Kern, Haag (DE); Frank Götz, Polling (DE); Priscilla Benedet-Eulenberger, Feldkirchen (DE); Andreas Eicher, Jettenbach (DE); Stefan Weigl, Mühldorf (DE)

(21) Appl. No.: 19/297,123

(22) Filed: Aug. 12, 2025

(30) Foreign Application Priority Data
Aug. 23, 2024 (DE) 10 2024 124 110.1

(51) Int. Cl. F04C 2/107

(52) U.S. Cl. CPC F04C 2/1075; F04C 2230/21; F04C 2230/60; F05C 2225/08

(57) ABSTRACT

An eccentric screw pump, with a stator body having a jacket and an elastic inner lining, with which the jacket is provided. According to a first aspect, the jacket and the inner lining are in each case formed with a thermoplastic plastic material. According to a second aspect, the jacket is formed with a thermoplastic plastic material, the inner lining is formed with a material with elastomeric properties and the stator body is produced in a two-component injection molding process or in an at least two-stage casting process. According to a third aspect, the jacket has a screw surface-like outer surface on the outer side at least in sections, which is modified area by area at least by means of additional demolding surfaces. According to a fourth aspect, a stator for an eccentric screw pump is further proposed, having an inner component or inner lining, which is provided for a cooperation with a rotor of the eccentric screw pump and which is formed with a thermoplastic elastomer or a thermoplastic polyurethane. An eccentric screw pump and a method for the production of a stator for an eccentric screw pump are further proposed.

### TECHNICAL FIELD

The invention relates to stators for eccentric screw pumps, to eccentric screw pumps with stators of this type and to a method for producing a stator for an eccentric screw pump.

### BACKGROUND

Eccentric screw pumps are known as such. Pumps of this type have a stator as well as a rotor, which rotates eccentrically in a passage of the stator. The passage of the stator as well as the rotor are provided with helically wound surfaces, which, in cooperation with one another, form conveying chambers for the medium to be conveyed during the operation of the eccentric screw pump.

A number of stator constructions for eccentric screw pumps have already been proposed.

In the case of a conventional construction, the helically wound inner surface of the stator is formed, for example, in an elastomer body and is thus elastically resilient. It can be accomplished in this way to form a sealing line around each of the conveying chambers with the help of a suitable dimensioning of the stator and rotor geometry. This provides for a pressure maintenance during the conveyance of a medium to be conveyed. In the case of such a construction, the elasticity of the stator inner surface can additionally help improve the wear behavior and the service life of the stator, especially when abrasive media, which contain sand or the like, for example, are to be conveyed.

In the case of the above-mentioned conventional construction, a steel pipe is initially produced and processed separately, in order to produce the stator. An elastomer is injected into this steel pipe, in order to form the elastomer body and to connect it to the steel pipe. Prior to the injection of the elastomer, this approach includes, in particular, a degreasing and sandblasting of the steel pipe as well as the application of an adhesion-improving coating, which is formed with two individual layers, as pre-treatment. The coating constructed with a primer layer and with an adhesion-promoting layer serves the purpose of a reliable, fixed and permanent connection of steel and elastomer.

Stators have further been proposed, in the case of which a fixed jacket is subsequently arranged in a detachable manner around an elastomer body during the assembly of the stator, without permanently adhesively fixing the elastomer body and the jacket to one another.

Conventional stator constructions with a fixed metal jacket furthermore exist, for instance of steel, cast aluminum or cast steel, which provide for an even wall thickness of the inner elastic material received by the jacket.

Pure elastomer stators or also stators purely of non-elastically resilient plastics, such as PA (polyamide) or PTFE (polytetrafluoroethylene)—so-called solid stators—have already been proposed. Stators of this type thus have a hard, rigid inner surface.

The current, conventional approach for producing a stator for an eccentric screw pump with a supporting jacket as well as the option of a pressure maintenance or overcoming of a counter-pressure by forming a sealing line is thus relatively complex and expensive.

For example, the production of the vulcanized elastomer body is thus already complex as well as energy- and cost-intensive. The production of the metal jacket and the mechanical processing thereof are also energy-consuming and expensive.

The connection of the elastomer to the metal surface of the jacket additionally requires a multi-step, time-consuming pre-treatment, in order to attain a good adhesion of both to one another.

As component of the eccentric screw pump, the stator is usually further exposed to wear during operation. A repeated exchange of the stator can thus be required. The presence of the elastomer body, in particular in the fixed bond with the metal jacket formed as steel pipe, hereby makes the recycling of a worn stator more difficult. The reuse of an elastomer on its own is already difficult.

In light of the foregoing, it would be desirable to have an improved construction of a stator for an eccentric screw pump, the production of which is less complex and more economical and which is preferably also more sustainable with regard to the production process.

### SUMMARY

In light of the foregoing, it is thus an object of the present invention to specify a stator for an eccentric screw pump, which avoids or mitigates at least one, some or all of the above-mentioned disadvantages. A correspondingly improved eccentric screw pump as well as a correspondingly improved method for the production of a stator for an eccentric screw pump are to further be provided.

According to the invention, this object is solved by means of a stator for an eccentric screw pump with the features of the claims and/or by means of a stator for an eccentric screw pump with the features of the claims and/or by means of a stator for an eccentric screw pump with the features of the claims and/or by means of an eccentric screw pump with the features of the claims and/or by means of a method with the features of the claims.

In a first aspect of the invention, a stator for an eccentric screw pump is thus proposed, with a stator body having a supporting jacket and an elastic inner lining, with which the jacket is provided. The jacket and the inner lining are hereby in each case formed with a thermoplastic plastic material.

According to a second aspect of the invention, a stator for an eccentric screw pump is provided, with a stator body having a supporting jacket and an elastic inner lining, with which the jacket is provided, wherein the jacket is formed with a thermoplastic plastic material, the inner lining is formed with a material with elastomeric properties and the stator body is produced in a two-component injection molding process or in an at least two-stage casting process.

According to a third aspect of the invention, a stator for an eccentric screw pump is furthermore proposed, with a stator body having a jacket and an elastic inner lining, with which the jacket is provided on the inner side, wherein the jacket has a screw surface-like outer surface on the outer side at least in sections, for example double-threaded screw surface-like outer surface, which is modified area by area at least by means of additional demolding surfaces.

According to a fourth aspect of the present invention, the above-described object of the invention is furthermore solved by means of a stator for an eccentric screw pump, having an inner component or inner lining, which is provided for a cooperation with a rotor of the eccentric screw pump and which is formed with a thermoplastic elastomer or a thermoplastic polyurethane.

An eccentric screw pump with a rotor and a stator formed according to the invention is furthermore provided. The stator is hereby formed for a cooperation with the rotor and receives the rotor at least in sections.

The invention further creates a method for producing a stator for an eccentric screw pump, in particular for producing a stator formed according to the invention. In the case of the method according to the invention, a stator body of the stator is formed with a jacket of a thermoplastic plastic material and the jacket is provided with an inner lining of a material with elastomeric properties. The stator body is hereby produced in a two-component injection molding process or in an at least two-stage casting process.

An idea on which the invention is based is that the formation of the elastic inner lining as well as of the jacket in each case with a thermoplastic plastic material provides for a significant reduction of the effort, of the manufacturing time and of the energy input for the production of the stator.

In the case of the formation of the elastic inner lining or inner component with a thermoplastic material, significant energy savings can be achieved compared to the generation and vulcanization of an elastomer body. The generation of the jacket with a thermoplastic plastic material instead of a metal also provides for a significant reduction of effort and energy consumption. It can thus be accomplished by means of the invention to significantly reduce the CO₂ footprint (so-called “product carbon footprint” or PCF, in short) and to produce the stator in a more sustainable, resource-saving manner. By means of the formation of jacket and inner lining in each case with a thermoplastic plastic material, a fixed and reliable adhesive connection between these component parts can additionally be achieved with little effort.

For example, it is further provided according to an idea of the invention to recycle the stator body with the fixed bond of jacket and inner lining as a whole as a mono material component when using thermoplastic materials in particular of the same variety or material family, which are set differently, for example, with respect to one or several mechanical property/properties of the materials for jacket and inner lining. For example, the used stator body can be shredded and can be comminuted into a granulate, which can be further processed, preferably after a cleaning. Such a granulate can then be processed, for example, on a conventional injection molding machine, like a fresh plastic granulate, or can instead be sold, for example, to a material compounder. In this way, the invention creates a stator of an eccentric screw pump with elastic inner lining and good performance, which can additionally be equipped with an improved recyclability.

In an advantageous manner, the proposed formation of the jacket with a thermoplastic plastic material provides for a comparatively free geometric designability thereof, so that, for example, the jacket can follow an inner geometry of the stator, for instance in helical form, and a wall thickness of the inner lining can thus be optimized for the further improvement of the producibility and can be designed more evenly, for example. The component weight of the finished stator can additionally also be reduced in this way, in particular in combination with the thermoplastic inner lining, formed for instance with a thermoplastic elastomer or thermoplastic polyurethane, which helps reduce the resource consumption during the production of the stator and the CO₂ emission in connection with the shipment thereof and contributes to a simpler handling of the stator during the production as well as with the customer.

The production of the stator body in a two-component injection molding process or in an at least two-stage casting process makes it possible to achieve a good connection of jacket and inner lining with little effort, in particular in each case by means of the injection molding of the jacket and/or of the inner lining. This also contributes to an economical and sustainable generation of the stator. Injection molding or casting processes of this type, respectively, in particular in each case by means of the injection molding of the jacket, additionally make it possible to vary the geometry of the jacket in a simple way and within wide boundaries and to adapt the geometry of the jacket to the inner geometry of the stator, in particular without or with only little additional costs, with the advantages of a good producibility and low component weight, which have already been mentioned above.

The demolding surfaces provided according to an aspect of the invention further simplify the production of the stator body and contribute to an even more economical and more cost-efficient production. It in particular becomes possible by means of the demolding surfaces to produce the stator body in a simply constructed casting tool, in particular in a slider-free two-plate tool. The demolding surfaces can preferably be arranged in such a way that undercuts are avoided, which would obstruct a simple separation of the tool plates in the separating plane without separately providing movable tool elements.

The use provided according to a further aspect of the invention of a thermoplastic elastomer or of a thermoplastic polyurethane as thermoplastic plastic material for the formation of the inner component or inner lining contributes to an economical and sustainable generation of the stator, in particular with reduced product carbon footprint, already on its own as well as in particular in combination with the jacket made with the thermoplastic material. In combination with a thermoplastic jacket, the thermoplastic elastomer or the thermoplastic polyurethane can in each case contribute to an advantageous recyclability of the stator.

For example, the invention can provide for a cost reduction compared to the conventional approach with an elastomer body, which is fixedly connected to a steel jacket, by up to approximately 70 percent and for a reduction of the product carbon footprint or PCF, respectively, by up to approximately 70 to 80 percent.

Advantageous designs and further developments of the invention follow from the subclaims as well as from the description with reference to the drawings.

The stator body is in particular produced in a two-component injection molding process. This provides for a reliable connection of jacket and inner lining with little effort, an economical and sustainable generation as well as a complex geometry of the jacket with little additional costs, wherein the producibility, in turn, can be improved and the weight of the stator can be reduced by means of the option of a complex jacket geometry, for example in that the jacket essentially follows the geometry of the inner lining or component.

In a further development, the jacket in particular forms a direct bond with the inner lining. Construction and production of the of the stator body are simplified in this way. A complex intermediate layer for improving the adhesion of jacket and inner lining can be omitted. A direct bond can in particular be achieved by means of the two-component injection molding process or the at least two-stage casting process, in the case of which in particular an injection molding of jacket and inner lining in each case takes place in separate stages of the process.

According to one design, the inner lining is formed with an essentially even wall thickness. This advantageously provides for an improved production of the inner lining in an injection molding/casting process, in particular with a thermoplastic plastic material, such as, for instance, a thermoplastic elastomer (TPE) or a thermoplastic polyurethane (TPU). An even wall thickness, which is as constant as possible, is advantageous in particular when processing TPE or TPU, in particular because unfavorable material accumulations, the formation of voids and deformation are avoided in this way. An even wall thickness additionally avoids excessively long cool-down times during the injection molding of the inner lining and provides for an economical production process in this way.

In a further development, the jacket is connected to the inner lining on the inner side at a connecting surface, which is formed in a screw surface-like manner at least in sections and which can in particular be formed in a double-threaded screw surface-like manner. A stator body is generated in this way, in the case of which jacket and inner lining can be handled together as a whole and the inner lining is reliably supported mechanically on the outer side by means of the jacket and is provided with pressure stability.

On the outer side, the jacket in particular has a screw surface-like outer surface at least in sections, in particular a double-threaded screw surface-like outer surface. An essentially even wall thickness of the inner lining/component, which is advantageous for the production process, can be achieved by means of a jacket, which is coiled in this way and thus by means of an outer surface of this type, and an at least largely even wall thickness of the jacket can simultaneously also be made possible. Such a relatively complex shaping of the jacket can be accomplished by means of a thermoplastic plastic material for the latter in a comparatively simple and cost-efficient manner and thus simplifies the production of the inner lining with even wall thickness of a TPE or TPU.

In one design of the invention, the jacket can be reinforced on the outer side by means of reinforcing ribs, which are preferably formed integrally with the jacket. The mechanical support function of the jacket can be improved even further in this way. The reinforcing ribs can extend, for example, on the stator body along the latter.

In one design, an outer contour of the jacket can be formed in such a way that a production of the stator body is made possible in a slider-free two-plate tool. The producibility in the slider-free two-plate tool can in particular be made possible in this design by means of a defined number, shape and size of demolding surfaces, which are provided on the outer side of the jacket.

The screw surface-like outer surface can in particular be modified area by area at least by means of additional demolding surfaces. Deforming surfaces of this type simplify an economical, cost-efficient production of the stator body and help avoid complicated molding tools, for instance for the injection molding. For example, the deforming surfaces can be arranged in such a way that the stator body can be produced and can be deformed in an undercut-free manner in a slider-free two-plate tool.

According to one design, the deforming surfaces are in each case formed to be essentially flat or to be essentially flat at least in sections. This provides for simply designed demolding surfaces, which can also be used for further purposes, in particular for the contacting of mechanical tools or the contacting of transport or holding means. Instead of a flat design of the demolding surfaces, however, it can be provided that the demolding surfaces are in each case not formed to be flat, provided that the shaping of the demolding surface prevents undercuts in the viewing direction to the separating plane of the molding tool. In a different design, the deforming surfaces can in each case be formed in a curved manner, for example, and can hereby in particular be formed from generatrixes, which are parallel to one another.

According to a further development, a wall thickness of the jacket is reduced in the area of the demolding surfaces compared to other areas of the jacket, in which the latter has the screw surface-like outer surface. Due to the fact that the reduction of the wall thickness of the jacket is limited to the areas of the demolding surfaces in this way, an excessively uneven wall thickness of the jacket is prevented. The use of resources for the jacket production can be limited at the same time and a stator with reduced weight can be provided, which can simultaneously be produced in an expedient manner.

In a further design, the deforming surfaces are arranged on the outer side of the jacket on both sides of the center plane with respect to a center plane of the stator, in which a longitudinal stator axis of said stator lies. The center plane can hereby correspond in particular to a separating plane of a molding tool, for instance injection molding tool. In a further development, the demolding surfaces of the center plane can in particular be arranged adjacently. In another further development, it can in particular be provided that the jacket is provided with reinforcing ribs on the outer side and that the demolding surfaces are arranged adjacently to at least one of the reinforcing ribs.

In a further development, two or more of the demolding surfaces are provided in each case on the outer side of the jacket on both opposite longitudinal sides of the stator.

According to a further design, the demolding surfaces are formed and arranged in such a way that the demolding surfaces or at least some of them can be used
to handle the stator or the jacket or both during the production of the stator or
to handle the stator during the assembly thereof on a rotor of the eccentric screw pump or
for such handling processes in combination.

The demolding surfaces can thus be equipped with additional functions and can serve as assembly aid during the installation of the stator into the pump and/or as handling aid in the production. The demolding surfaces can hereby in particular be suitable or provided as contact surfaces for a handling tool or handling means or for an assembly tool. The handling in the production can hereby in particular take place in an automated manner, for instance by means of a robot. Additionally or alternatively, the demolding surfaces can also serve as aid during a manual assembly with or without tool or a manual handling with or without handling means, respectively.

The inner lining is in particular formed with a thermoplastic elastomer or a thermoplastic polyurethane. A material selection of this type for the inner lining provides for a more economical and more sustainable generation of the stator, wherein a reduced product carbon footprint can in particular also be achieved. In a combination with a thermoplastic jacket, the thermoplastic elastomer or the thermoplastic polyurethane can in each case additionally improve the recyclability of the stator.

In one design, the jacket is formed with a polyamide or a polypropylene or a thermoplastic polyurethane.

According to another further development, it is provided that
the inner lining is formed with a thermoplastic elastomer and the jacket is formed with a polypropylene; or that
the inner lining is formed with a thermoplastic elastomer and the jacket is formed with a polyamide; or that
the inner lining is formed with a thermoplastic polyurethane and the jacket is formed with a polyamide; or that
the inner lining is formed with a thermoplastic polyurethane, which is set to be soft, and the jacket is formed with a thermoplastic polyurethane, which is set to be hard.

A plurality of exemplary material combinations are thus possible in order to create an economic, sustainable stator for an eccentric screw pump, which is adapted for a large variety of fields of application, for instance with regard to the medium to be conveyed and/or the stability of the stator in contact with this medium. In addition, the above-mentioned material combinations for jacket and inner lining can significantly improve the recyclability.

In an alternative design of the invention, it can be provided that the inner lining is formed with a cross-linked elastomer and in particular that the jacket is formed with a polyamide. It can be achieved hereby, for example with the use of an injection molding process, for example two-component injection molding process or two-stage injection molding process, that the inner lining is connected directly as elastomer component to the jacket, thus forms a direct bond, without interconnecting one or several adhesion-promoting layer(s). This, in turn, provides for a simplification of the production process, wherein a plurality of processing steps for the jacket as well as for a complex preparation of the jacket for ensuring a good adhesion are avoided. Coating means for promoting adhesion are also saved in an advantageous manner hereby. A stator body with a plastic-rubber direct bond can thus be produced. The latter can be produced independently of the jacket geometry, for example also with a cylindrical jacket. The plastic-rubber direct bond can in particular be realized by means of a combination, which is suitable for this purpose, of the thermoplastic plastic material for the jacket and of the elastomer for the inner lining, wherein in particular a polyamide is preferred for the jacket. A design of this type, in turn, provides for the generation of a stator in a more economical and more sustainable manner.

In a design of the fourth aspect, the stator can further have a supporting jacket, wherein the jacket is produced as a separate component and the inner component is received in the jacket or the jacket is connected to the inner lining to form a stator body. The jacket is hereby preferably formed with a thermoplastic plastic material, wherein the jacket is in particular formed with a polyamide or a polypropylene or a thermoplastic polyurethane.

In designs of the fourth aspect, it can be provided that
the inner lining or inner component is formed with a thermoplastic elastomer and the jacket is formed with a polypropylene; or that
the inner lining or inner component is formed with a thermoplastic elastomer and the jacket is formed with a polyamide; or that
the inner lining or inner component is formed with a thermoplastic polyurethane and the jacket is formed with a polyamide; or that
the inner lining or inner component is formed with a thermoplastic polyurethane, which is set to be soft, and the jacket is formed with a thermoplastic polyurethane, which is set to be hard.

In a further development of the fourth aspect of the invention, the jacket can have a screw surface-like outer surface on the outer side at least in sections and the screw surface-like outer surface can be modified area by area at least by means of additional demolding surfaces.

The stators proposed according to the invention can in each case be used, for example, as construction material stator, wherein a variety of other applications of the stators proposed according to the invention are instead likewise possible and useful for the large variety of conveying media as well as the large variety of eccentric screw pumps and applications.

### BRIEF DESCRIPTION OF THE DRAWINGS

The invention will be described in more detail with reference to exemplary embodiments, which are illustrated in the enclosed drawings.

The enclosed drawings are included in order to provide for a further understanding of this invention and are included in this description and represent a part thereof. The drawings illustrate the embodiments of this invention and, together with the description, serve the purpose of explaining the principles of the invention. Other embodiments of this invention and many of the provided advantages of this invention can be understood easily when they become easier to understand by referring to the following detailed description. The elements of the drawings are not necessarily drawn at the same scale to one another. Identical reference numerals accordingly identify similar parts.

FIG. 1 shows an eccentric screw pump according to an exemplary embodiment in a schematically simplified side view;

FIG. 2 shows a stator for the eccentric screw pump of FIG. 1 according to the exemplary embodiment in a side view;

FIG. 3 shows the stator of FIG. 2 in a view in a cross section A-A, as suggested in FIG. 2;

FIG. 4 shows the stator of FIG. 2 in a view in a longitudinal section B-B, as suggested in FIG. 2;

FIG. 5 shows the stator of FIG. 2 in a view in a further cross section C-C, as suggested in FIG. 4;

FIG. 6 shows the stator according to the exemplary embodiment of FIG. 2 in a first perspective view;

FIG. 7 shows a detail D of the perspective view from FIG. 6;

FIG. 8 shows a further perspective view of the stator in correspondence with the exemplary embodiment of FIG. 2;

FIG. 9 shows a stator for an eccentric screw pump like the one of FIG. 1 according to another exemplary embodiment in a side view;

FIG. 10 shows the stator of FIG. 9 in a view in a longitudinal section F-F, as suggested in FIG. 9;

FIG. 11 shows the stator of FIG. 9 in a view in a cross section E-E, as suggested in FIG. 9;

FIG. 12 shows the stator of FIG. 9 in a view in a further cross section G-G, as suggested in FIG. 10;

FIG. 13 shows the stator of FIG. 9 in a first perspective view; and

FIG. 14 shows a further perspective view of the stator of FIG. 9.

Unless stated otherwise, identical reference numerals identify identical or functionally similar components in the figures. All directional terms, such as, “top”, “bottom”, “left”, “right”, “above”, “below”, “horizontal”, “vertical”, “rear”, “front” and similar terms are used only for explanatory purposes and are not to limit the embodiments to the specific arrangements, which are illustrated in the drawings.

### DETAILED DESCRIPTION

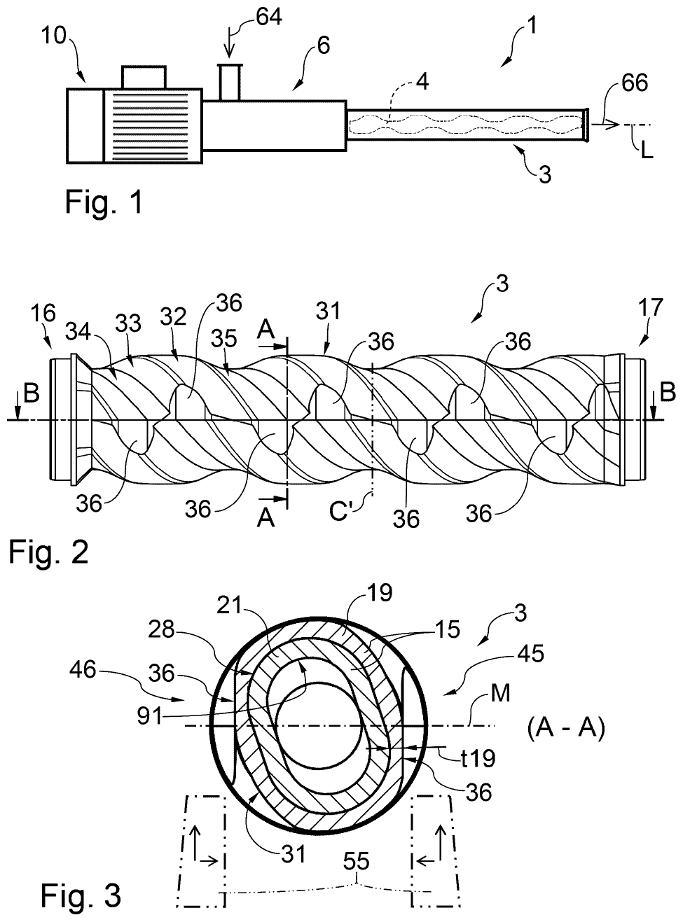

An eccentric screw pump 1 is shown in FIG. 1 in a schematically simplified side view. The eccentric screw pump 1 has a stator 3, which is coupled on the supply side to a housing 6 in the shown exemplary embodiment. As is schematically suggested by means of an arrow 64, the housing 6 conveys the supply of a conveying medium to an input side of the stator 3. On the output side, the medium to be conveyed is discharged in a conveying direction, which is suggested in FIG. 1 with an arrow 66. It goes without saying, however, that the eccentric screw pump 1 of FIG. 1 is illustrated in an illustrative and exemplary manner and that the stator 3, which will be described in more detail below, and the variations thereof can be used analogously in the case of other types of eccentric screw pumps 1.

The stator 3 is an elongated component with a longitudinal stator direction L. Along the direction L, the stator 3 has a passage 13 with an inner surface, which is wound in a screw surface-like manner, not shown in more detail in FIG. 1. A rotor 4 with an outer surface, which is wound in a screw surface-like manner, is arranged in the passage 13. During operation of the eccentric screw pump 1, the rotor 4 can rotate eccentrically in the passage 13 of the stator 3. A drive 10, having, for example, an electric motor, serves to drive the rotor 4.

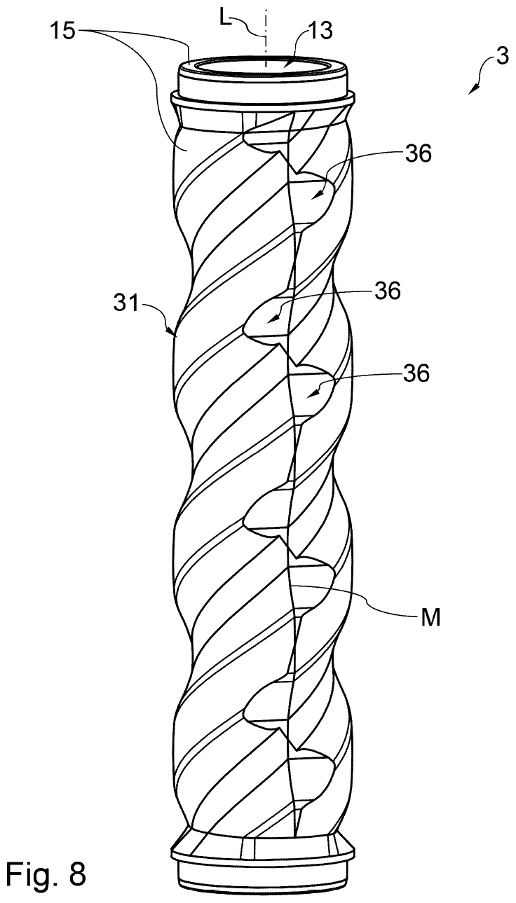

A stator 3 according to an exemplary embodiment, which can be used in the eccentric screw pump 1 of FIG. 1, is illustrated in FIGS. 2 to 8.

The stator 3 is formed with a stator body 15. The stator body 15 is shaped in a pipe-like manner and has a supporting, pipe-like jacket 19, which is provided with an elastic inner lining 21 on the inner side. While the jacket 19 thus has a mechanical support function and is made of a relatively rigid material, the inner lining 21 is made of a material with elastomeric properties. Along the longitudinal stator direction L, the stator body 15 is provided with the passage 13, which receives the rotor 4. An inner surface 91, which is wound in a screw surface-like manner, of the inner lining 21 surrounds the passage 13, starts cooperating with the rotor 4 during operation and is identified in FIGS. 3 to 5. In the case of the exemplary embodiment shown in FIGS. 2 to 8, the inner surface 91 is wound in a double-threaded screw surface-like or helical manner.

In the case of the exemplary embodiment of FIGS. 2-8, the jacket 19 and the inner lining 21 are in each case made of a thermoplastic plastic material and are fixedly connected directly to one another, without promoting an interconnected, separately applied adhesion-improving layer. The thermoplastic material of the inner lining 21 is a thermoplastic elastomer hereby, TPE in short, or a thermoplastic polyurethan, TPU in short, while in particular a polyamide, PA in short, or a polypropylene, PP in short, or a thermoplastic polyurethane (TPU) is selected as the thermoplastic plastic material of the jacket 19. In that the supporting jacket 19 is made of a thermoplastic plastic material and a thermoplastic elastomer or thermoplastic polyurethane is provided for the relatively soft inner lining 21, a fixed and reliable adhesion of jacket 19 and inner lining 21 can be achieved.

In variations of the exemplary embodiment of FIGS. 2-8, the following material combinations are provided, for example, for the jacket 19 and the inner lining 21 of the stator body 15:
the jacket 19 is made of PP, the inner lining 21 of TPE; or
the jacket 19 is made of PA, the inner lining 21 of TPE; or
the jacket 19 is made of PA, the inner lining 21 of TPU; or
the jacket 19 is made of TPU, the inner lining 21 likewise of TPU.

The material of the jacket 19 is hereby formed to be relatively rigid and hard, in each case by means of a suitable setting of the thermoplastic plastics, while the material of the inner lining 21 is embodied to be relatively soft and elastically resilient. With suitable dimensioning of the rotor 4, the rotor 4 can in this way form a sealing line with the inner surface 91 of the inner lining 21 in each case around conveying chambers, which form between the inner surface 91 and the rotor 4, whereby the eccentric screw pump 1 can build up and hold a pressure. Due to its relatively rigid, hard design, the jacket 19 can fulfill its mechanical support function for the inner lining 21 and can provide for pressure stability.

In one of the above-mentioned exemplary variations of the exemplary embodiment, the inner lining 21 is thus made of a thermoplastic polyurethane, which is set to be soft, and the jacket 19 is made of a thermoplastic polyurethane, which is set to be hard. A stator 3 of this type can thus be considered as being made of a mono material, TPU in the case of this variation. Such a stator 3 can be cleaned, supplied to the recycling as a whole and be comminuted here, for example, and processed into a reusable thermoplastic granulate in a simple way at the end of its service life, i.e., if the wear of the stator 3 exceeds a tolerable level. The other above-mentioned thermoplastic material combinations can likewise prove to be advantageous with regard to the recyclability.

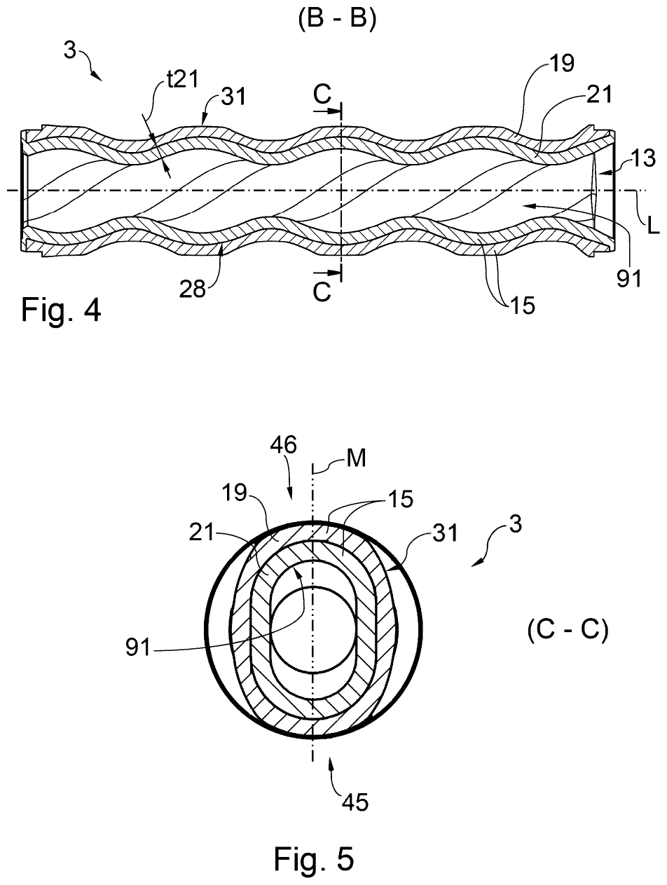

On its inner side, the inner lining 21 has the inner surface 91 and, viewed radially on the outer side, is connected to the jacket 19 on the inner side thereof on a connecting surface 28, which is essentially screw surface-like and which is similar to the inner surface 91, see FIGS. 3 and 4. FIGS. 3-5 further illustrate that the inner lining 21 has an essentially even, thus at least largely constant wall thickness t21, which is suggested schematically in the figures.

On the outer side, the jacket 19 likewise has a screw surface-like outer surface 31, which, in turn, is formed in a double-threaded manner in the case of the shown exemplary embodiment. The outer surface 31 essentially follows the connecting surface 28 and the inner surface 91 in parallel. In this way, the jacket 19 is likewise formed with a wall thickness t19, which is essentially even and largely constant across large parts of the jacket 19. This saves material and thus resources and contributes to a good producibility, as does the even wall thickness t21 of the inner lining 21.

FIG. 2 as well as 6 to 8 illustrate the outer surface 31 in different views. The outer surface 31 is hereby divided into several partial surfaces formed as screw surface pieces, wherein some of them are identified, for example, with 32, 33, 34, 35. Viewed in a longitudinal section, the partial surface 32 is a peak surface, the partial surface 33 is a first inclined, falling flank, the partial surface 34 is a valley surface and the partial surface 35 is a second inclined, rising flank of one of the screw threads of the outer contour of the stator body 15. One or both of the front side-end areas of the stator body 15 can be provided with connection or end geometries, for instance in the form of stepped cylindrical end sections 16 and/or 17, see FIGS. 2, 6 and 8, the outer surfaces of which are not part of the outer surface 31, which is formed in a screw surface-like manner.

In the case of the exemplary embodiment shown in the figures, the outer surface 31, which is formed as double-threaded screw surface, is modified in a plurality of partial areas by means of the introduction of surface sections 36, which deviate from the screw surface shape.

To produce the stator 3, the stator body 15 is produced in a two-component injection molding process or in an at least two-stage casting process, which in particular includes two separately guided injection molding steps.

A two-component injection molding process for producing the stator body 15 can be carried out in an advantageous and economical manner in a slider-free two-plate tool, for instance as a transfer process. For example, the two-plate tool hereby has two cavities, a first one for shaping the inner lining 21 as well as a second one for shaping the jacket 19. After an injection molding of the inner lining 21, the latter can be transferred from the first into the second cavity and can be overmolded there with the provided material for forming the jacket 19, as described above. In a variation of the exemplary embodiment, it can instead be provided that the jacket 19 is initially injection molded in a two-component injection molding process, then the inner lining 21, with which the jacket 19 is sprayed. The use of a two-component injection molding process makes it easier to achieve a good, reliable connection of jacket 19 and inner lining 21.

While the material, which is provided for producing the inner lining 21, has an elastic resilience, as described above, a rather rigid, fixed mechanical behavior is sought for the jacket 19. To prevent that the outer surface 31, which is formed in a screw surface-like manner, together with the rigid material properties of the jacket 19, would obstruct a spreading apart of the tool plates of a simple, slider-free two-plate tool due to undercuts, undercuts of this type, viewed in the direction to the center plane M, are eliminated by means of the surface sections 36. The center plane M hereby forms the separating plane of the molding tool. The surface sections 36 thus serve as demolding surfaces, which provide for the use of a simple tool for producing the jacket 19 and can thus contribute to lowering the production costs.

The wall thickness t19 of the jacket 19 is reduced in the area of the demolding surfaces 36, compared to other areas of the jacket 19, in which the latter has the unmodified screw surface-like outer surface 31. FIG. 3 illustrates this in an exemplary and schematically simplified manner in the cross section A-A. In the area of the demolding surfaces, the wall thickness t19 can be reduced, for example, to approximately 50 percent of the wall thickness of the jacket 19 in areas of unmodified screw surface-like outer surface 31.

The illustration of the wall thicknesses t21 and t19 in the figures is to be understood as illustration, whereby the actual wall thickness can be illustrated in a distorted manner in the cross sections normal to the axis and the axially parallel longitudinal section due to the screw surface shapes.

To remove the undercuts, which would obstruct a simple separating of the molding tool, the demolding surfaces 36—see FIG. 2, 3, 6-8—are arranged on the outer side of the jacket 19 on both sides of the center plane M with respect to the center plane M of the stator 3, in which the longitudinal stator axis L also lies, and are in each case provided adjacent to the center plane M. Two or more of the demolding surfaces 36 are hereby in each case provided on the outer side of the jacket 19 on two longitudinal sides 45 and 46 lying opposite one another. A demolding surface 36 is in each case provided through the center and separating plane M towards each side of the center plane M, in particular for each passage of the unmodified screw surface, on the basis of which the outer surface 31 is formed.

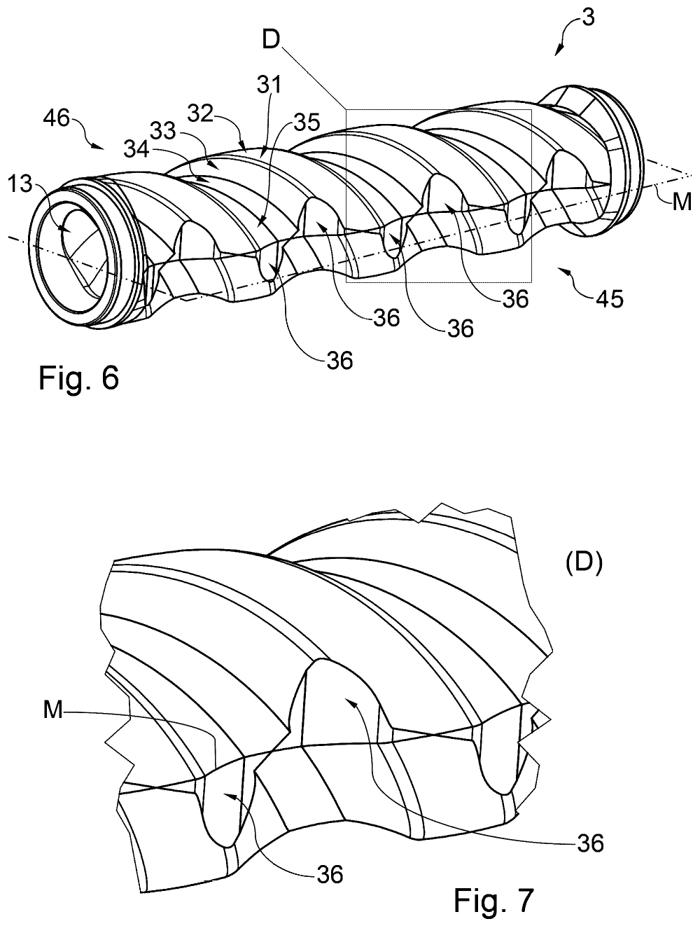

The demolding surfaces 36 can be formed, for example, with a rounding or curvature or to be essentially flat. In the case of the exemplary embodiment of FIGS. 2 to 8, see, for instance, FIGS. 6 to 8, the demolding surfaces 36 in each case have a slight curvature, but are in each case nonetheless formed from parallel generatrixes normal to the center plane M. Different, flat or non-flat designs of the demolding surfaces 36 are conceivable, provided that they are suitable to prevent the undercut close to the center plane M.

The demolding surfaces 36 on both longitudinal sides 45 and 46 are additionally formed and arranged in such a way that the demolding surfaces 36 or at least some of them can be used for handling the stator 3 or the stator body 15, respectively, or the jacket 19 or both of them during the production of the stator 3 and/or for handling the stator 3 during the assembly thereof on the rotor 4. For example, the demolding surfaces 36 or some of them can simplify the removal of the finished stator body 15 from the molding tool, after the injection molding of the jacket 19.

For example, the demolding surfaces 36 can hereby serves as contact surfaces for an assembly tool or handling tool or means. A tool or means 55 for the assembly or handling is shown schematically and in a purely exemplary manner in FIG. 3. The demolding surfaces 36 can thus be well suited, for example, to remove the completely injection molded stator body 15 from the molding tool in an automated manner, for example by means of a robot and a gripper as handling means 55. The demolding surfaces 36 can additionally simplify the screwing of the stator 3 onto the rotor 4, manually or by means of the assembly tool 55, at the customer. A flat or at least partly flat formation of the demolding surfaces 36 can be expedient for the use thereof for the assembly and/or handling, as has just been described, whereby this is not mandatory and differently shaped, for instance slightly curved demolding surfaces 36, can likewise be equally expedient for simplifying assembly and/or handling.

Even though it is preferred to provide the demolding surfaces 36 as explained above, in order to provide for a simple and economical production, the demolding surfaces 36 can be absent and a more complex molding tool can be used in the case of another variation of the exemplary embodiment described above with reference to FIGS. 2 to 8.

In a further variation of the exemplary embodiment described above with reference to FIGS. 2 to 8, the stator body 15 can be produced in a two-stage casting process instead of in a two-component injection molding process. The jacket 19 is hereby initially manufactured separately from the selected material by means of injection molding and the finished jackets 19 are in each case sprayed with the inner lining 21 at a later point in time, the inner lining 21 is thus in each case formed in the jacket 19 of the selected thermoplastic plastic, in particular TPE or TPU, by means of injection molding. However, in a further variation of the exemplary embodiment, in turn, the inner lining 21 can initially alternatively be made separately by means of injection molding of the selected thermoplastic plastic, in particular TPE or TPU, and the finished inner linings 21 can later in each case be provided with the jacket 19 by means of injection molding in a later operation.

In the case of the above exemplary embodiments, the jacket 19 preferably in each case forms a direct bond with the inner lining 21, in the case of which a separately applied adhesion-promoting layer is not required between jacket 19 and inner lining 21.

In further variations of the exemplary embodiment explained above with reference to FIGS. 1-8, it can be provided that the inner lining 21, instead of being permanently and adhesively connected to the jacket 19, is detachably arranged in a jacket. For this purpose, an inner component 21 is produced, which is formed as described above for the inner lining 21, but which is used as separate component. A thermoplastic elastomer or a thermoplastic polyurethane, of which the inner component is produced by means of an injection molding process, is hereby used as material for forming the inner component. The obtained inner component is then received as separate part in a supporting jacket without adhesive bond to the latter, wherein the jacket can be made of a thermoplastic plastic as described above, but instead also of a metal. In the case of this variation, a jacket of this type can, for example, be geometrically formed essentially as is described with regard to FIGS. 1-8. It can be provided that in the case of this variation, the jacket can be opened or disassembled, in order to be able to add the inner component made of TPE or TPU into the jacket.

In the case of another exemplary embodiment of the invention, it can be provided that the jacket 19, as in the case of the above-explained exemplary embodiments, is made of a thermoplastic plastic material, which is preferably set to be relatively hard, while the inner lining 21, in contrast to the above exemplary embodiments, is made with a cross-linked elastomer. A suitable polyamide can be selected as thermoplastic plastic material for the jacket 19, for example a polyamide from Evonik, which is available under the name VESTAMID®. The inner lining 21 is thus hereby formed with a rubber material, for example a synthetic rubber. In the case of this exemplary embodiment, the jacket 19 is initially injection molded from the thermoplastic plastic material selected for said jacket and the inner lining 21 is then introduced into the jacket 19 by means of injection molding of the elastomer. The inner lining 21 is formed in this way during the injection and the elastomer can connect to the jacket 19 during the cross-linking or vulcanization. In the case of this exemplary embodiment of the invention, the production of the stator body thus also takes place in a two-component injection molding process or two-stage casting process. The composition of the thermoplastic plastic material of the jacket 19 is hereby selected in such a way that the inner lining 21 forms a good adhesion with the supporting jacket 19, so that a plastic-rubber direct bond can be realized and an adhesion-promoting layer, which is to be applied separately, can be omitted, in turn.

In the case of the above-described exemplary embodiment with a stator body 15, which is formed with a plastic-rubber direct bond, the geometry of jacket 19 and inner lining 21 can be formed as described above with reference to FIGS. 1-8, thus analogously as in the case of the exemplary embodiment with thermoplastic inner lining 21, for instance of TPE or TPU. In variations, however, it can instead be provided in the case of the plastic-rubber direct bond that the thermoplastic jacket 19 is formed as an essentially cylindrical pipe with cylindrical connecting surface to the inner lining. The wall thickness of the elastomeric inner lining thus varies in such a case.

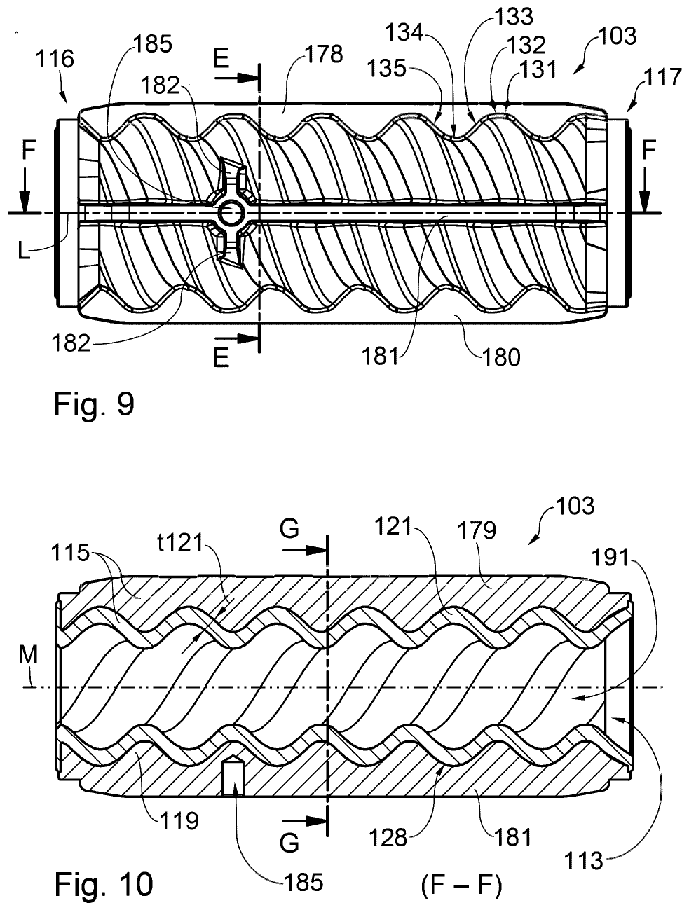

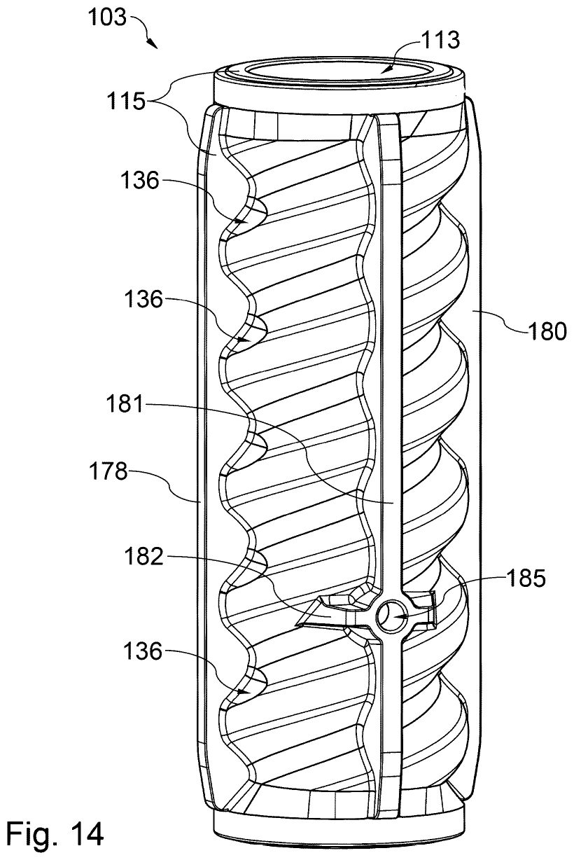

A stator 103 according to yet a further exemplary embodiment is illustrated in FIGS. 9 to 14. Except for the below-described differences, the stator 103 is formed like the stator 3 illustrated in FIGS. 2 to 8 and can be used essentially analogously to the stator 3 in an exemplary eccentric screw pump 1, as illustrated in FIG. 1. Elements and features of the stator 103, which correspond to those of the stator 3, are provided with reference numerals, which are formed from the reference numerals of the features of the stator 3 and by adding 100 to them in each case.

The stator 103 differs from the stator 3 in particular in that a jacket 119 of the stator 103, made of a thermoplastic plastic material, such as, for instance, a polyamide, a polypropylene or a TPU set to be hard, is provided with outer-side reinforcing ribs 178, 179, 180 and 181, which in each case extend essentially parallel to the longitudinal stator axis L on the stator body 115 and thus on the stator 103. The reinforcing ribs 178-181 reinforce the stator 103 against a bending about a transverse axis and increase the strength thereof with respect to mechanical forces along the longitudinal stator axis L.

During the production of the jacket 119, in particular by means of injection molding by overmolding an inner lining 121 or, for example, during the injection molding of the jacket 119 prior to the spraying thereof with the inner lining 121, the reinforcing ribs 178-181 are manufactured in one piece with the jacket 119 and are thus made of the same thermoplastic plastic material as the jacket 119.

The reinforcing rib 181 is additionally formed with a recess 185, which extends radially, in particular a round blind hole, which can be used, for example, for fastening or connecting purposes, for instance by means of a screw. The recess 185 is surrounded by a hollow cylindrical widening of the rib 181, which is also laterally reinforced in a direction transversely to a main direction of extension of the reinforcing rib 181 by means of additional transverse ribs 182, in order to be able to deflect possible load applications into the jacket 119 at the location of the recess 185.

Viewed in the cross section of the stator 103, the four reinforcing ribs 178-181 are arranged so as to be evenly distributed around the longitudinal stator axis L at intervals of essentially 90 degrees and extend radially outwards.

Even though four reinforcing ribs 178-181 are shown for the example of FIGS. 9-14 in the present case, it goes without saying that more or fewer reinforcing ribs can be provided in the case of variations of this exemplary embodiment. For example, only two reinforcing ribs can be provided, which are arranged approximately opposite one another by 180 degrees, or more than four reinforcing ribs could be provided, for instance six or eight, which are in particular arranged so as to be distributed evenly over the stator circumference.

In the case of the stator 103 according to the exemplary embodiment of FIGS. 9-14, the inner lining 121 is injection molded of a thermoplastic plastic material with elastomeric properties, preferably a TPE or a TPU.

In the case of the exemplary embodiment of FIGS. 9-14, the center plane M, which coincides with a separating plane of a molding tool, in particular injection molding tool, for a stator body 115 formed with the jacket 119 and the inner lining 121, lies centrally within each of the reinforcing ribs 180 and 178, which are arranged so as to be opposite one another by 180 degrees, see FIGS. 13, 9 and 11.

Except for the area of the ribs 180, 178, demolding surfaces 136 are arranged on an outer surface 131 of the jacket 119 in a manner analogously to the demolding surfaces 36, in order to eliminate undercuts in the viewing direction onto the center and separating plane M. With the exception of the demolding surfaces 136, the areas of the reinforcing ribs 178-182 and the recess 185, the outer surface 131 is essentially formed in a screw surface-like manner, analogously to the exemplary embodiment of FIGS. 2-8, in FIGS. 9-14 in a double-threaded screw surface-like manner, in turn. A screw surface, on which the outer surface 131 is based, is thus modified by means of the ribs 178-182 as well as by means of the demolding surfaces 136.

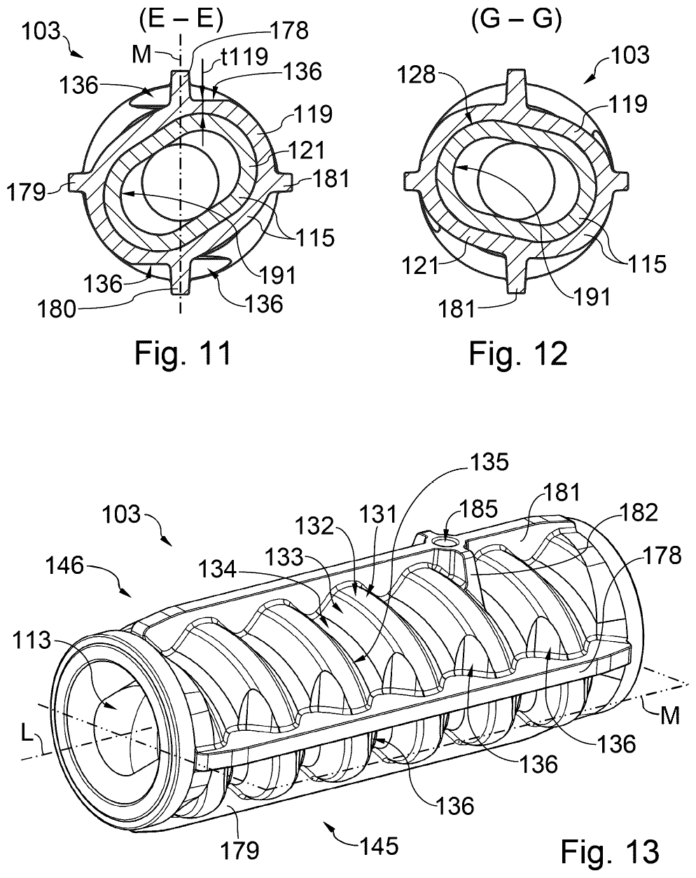

The sectional views of FIGS. 10 and 11 additionally make it clear that a wall thickness t121 of the jacket 121, as also in the case of the exemplary embodiment of FIGS. 2-8, is essentially constant, which improves the producibility of the inner lining 121 in particular of TPE or TPU, and that a wall thickness t119 in the area of the demolding surfaces 136 is reduced compared to other areas of the jacket 119, in which the outer surface 131 thereof is designed in a screw surface-like manner, essentially analogously to what has been described above for the wall thickness t19.

In variations thereof, the stator 103 can be modified as described above for the variations of the stator 3 and, in another exemplary embodiment, in turn, can further alternatively be made with a plastic-rubber direct bond, as likewise described above for a variation of the stator 3.

Even through the invention has been described completely above on the basis of preferred exemplary embodiments, it is not limited thereto but can be modified in a variety of ways.

1. A stator for an eccentric screw pump, comprising a stator body having a supporting jacket and an elastic inner lining, with which the jacket is provided, wherein the jacket and the inner lining are in each case formed with a thermoplastic plastic material.

2. The stator for an eccentric screw pump according to claim 1, wherein the stator body is produced in a two-component injection molding process.

3. A stator for an eccentric screw pump, comprising a stator body having a supporting jacket and an elastic inner lining, with which the jacket is provided, wherein the jacket is formed with a thermoplastic plastic material, the inner lining is formed with a material with elastomeric properties and the stator body is produced in a two-component injection molding process or in an at least two-stage casting process.

4. The stator for an eccentric screw pump according to claim 1, wherein the jacket forms a direct bond with the inner lining.

5. The stator for an eccentric screw pump according to claim 1, wherein the inner lining is formed with an essentially even wall thickness.

6. The stator for an eccentric screw pump according to claim 1, wherein the jacket is connected to the inner lining on the inner side at a connecting surface, which is formed in a screw surface-like manner at least in sections and which is in particular formed in a double-threaded screw surface-like manner.

7. The stator for an eccentric screw pump according to claim 1, wherein on the outer side, the jacket has a screw surface-like outer surface at least in sections, in particular a double-threaded screw surface-like outer surface.

8. The stator for an eccentric screw pump according to claim 7, wherein the screw surface-like outer surface is modified area by area at least by means of additional demolding surfaces.

9. A stator for an eccentric screw pump, comprising a stator body having a jacket and an elastic inner lining with which the jacket is provided on the inner side, wherein the jacket has a screw surface-like outer surface on the outer side at least in sections, which is modified area by area at least by means of additional demolding surfaces.

10. The stator for an eccentric screw pump according to claim 8, wherein the demolding surfaces are in each case formed to be essentially flat or essentially flat at least in sections or that the demolding surfaces are in each case formed to be curved and are in particular hereby formed from generatrixes, which are parallel to one another.

11. The stator for an eccentric screw pump according to claim 8, wherein a wall thickness of the jacket is reduced in the area of the demolding surfaces compared to other areas of the jacket, in which the latter has the screw surface-like outer surface.

12. The stator for an eccentric screw pump according to claim 8, characterized in that the deforming surfaces are arranged on the outer side of the jacket on both sides of the center plane with respect to a center plane of the stator, in which a longitudinal stator axis of said stator lies and in particular that the demolding surfaces are arranged adjacent to the center plane or that the jacket is provided with reinforcing ribs on the outer side and that the demolding surfaces are arranged adjacently to at least one of the reinforcing ribs.

13. The stator for an eccentric screw pump according to claim 8, wherein two or more of the demolding surfaces are provided in each case on the outer side of the jacket on both opposite longitudinal sides of the stator.

14. The stator for an eccentric screw pump according to claim 8, wherein the demolding surfaces are formed and arranged in such a way that the demolding surfaces or at least some of them can be used
to handle the stator or the jacket or both during the production of the stator or
to handle the stator during the assembly thereof on a rotor of the eccentric screw pump or
for such handling processes in combination,
in particular are suitable or provided as contact surfaces for a handling tool or a mounting tool.

15. The stator for an eccentric screw pump according to claim 1, wherein the inner lining is formed with a thermoplastic elastomer or a thermoplastic polyurethane.

16. The stator for an eccentric screw pump according to claim 1, wherein the jacket is formed with a polyamide or a polypropylene or a thermoplastic polyurethane.

17. The stator for an eccentric screw pump according to claim 1, wherein that
the inner lining is formed with a thermoplastic elastomer and the jacket is formed with a polypropylene; or that
the inner lining is formed with a thermoplastic elastomer and the jacket is formed with a polyamide; or that
the inner lining is formed with a thermoplastic polyurethane and the jacket is formed with a polyamide; or that
the inner lining is formed with a thermoplastic polyurethane, which is set to be soft, and the jacket is formed with a thermoplastic polyurethane, which is set to be hard.

18. The stator for an eccentric screw pump according to claim 4 wherein the inner lining is formed with a cross-linked elastomer and in particular that the jacket is formed with a polyamide.

19. An eccentric screw pump comprising a rotor and a stator for an eccentric screw pump, with a stator body having a supporting jacket and an elastic inner lining, with which the jacket is provided, wherein the jacket and the inner lining are in each case formed with a thermoplastic plastic material wherein the stator is formed for a cooperation with the rotor and receives the rotor at least in sections.

20. A method for producing a stator for an eccentric screw pump, in particular of a stator for an eccentric screw pump, with a stator body having a supporting jacket and an elastic inner lining, with which the jacket is provided, wherein the jacket and the inner lining are in each case formed with a thermoplastic plastic material, wherein the method includes the steps that a stator body of the stator is formed with a jacket of a thermoplastic plastic material and the jacket is provided with an inner lining of a material with elastomeric properties, wherein the stator body is produced in a two-component injection molding process or in an at least two-stage casting process.
